(19) United States
(12) Patent Application Publication
(10) Pub. No.: US 2023/0187994 A1
(43) Pub. Date: Jun. 15, 2023

(54) ELECTRIC MOTOR WITH FIBROUS COMPOSITE INSULATION FOR REDUCING BEARING ARCING

(71) Applicant: Nidec Motor Corporation, St. Louis, MO (US)

(72) Inventors: Liming Zhou, Chesterfield, MO (US); Mark D. Weisheit, Hoffman Estates, IL (US)

(73) Assignee: Nidec Motor Corporation, St. Louis, MO (US)

(21) Appl. No.: 18/065,528

(22) Filed: Dec. 13, 2022

Related U.S. Application Data
(60) Provisional application No. 63/289,001, filed on Dec. 13, 2021.

(51) Int. Cl. H02K 5/08; H02K 5/173

(52) U.S. Cl. CPC H02K 5/08; H02K 5/1732

(57) ABSTRACT

An electromagnetic apparatus produces an asymmetrical magnetic field. The electromagnetic apparatus includes a stator and a rotor rotatable relative to the stator. The stator includes electrically conductive wiring subject to non-zero voltage input. The rotor includes an electrically conductive rotor shaft having a shaft voltage induced therein. The electromagnetic apparatus further includes a bearing rotatably supporting the rotor shaft and an electrically insulative arcing shield disposed in overlying engagement with the bearing. The arcing shield comprises a fibrous composite material. The fibrous composite material includes a plurality of fibers and a resin.

### CROSS-REFERENCE TO RELATED APPLICATION

### 1. Priority Application

The present application claims the benefit of and priority from U.S. Provisional Patent Application No. 63/289,001, filed Dec. 13, 2021, the entire disclosure of which is hereby incorporated by reference herein.

### BACKGROUND OF THE INVENTION

### 1. Field of the Invention

The present invention relates generally to electrical insulation of motor/generator bearing assemblies to reduce or prevent arcing.

### 2. Discussion of the Prior Art

Conventional electric motors may be designed to operate on a polyphase power source. In some such motors, a standard input voltage is provided. The associated phase wave form is a sine wave, and the common mode voltage is zero. That is, the motor exhibits balanced power, and no shaft voltage is induced.

However, other electric motors may instead induce a voltage in the shaft. For instance, in some electric motors, the input waveform is instead a conversion from multiple electronic control devices in which micro-transistors and high speed diodes convert the sine wave form into a series of step pulses. In such a motor, if a variable frequency drive (VFG) or variable speed drive (VSD) is used, the step pulse of three-phase voltage under any moment relative to ground is always non-zero, and the voltage input into the motor winding is never balanced. This results in the presence of a common voltage mode that causes the motor rotor assembly to charge as a capacitor of sorts. A voltage on the rotor assembly may then be induced through capacitive coupling due to isolation of the shaft assembly from the stator assembly by bearing grease.

The induced voltage due to the presence of common mode will continue to build up and is stored within the rotor and/or shaft. Once the voltage exceeds the break-down voltage of the bearing grease, the rotor and/or shaft may discharge the stored voltage as a capacitor and strike the bearing raceway as burst of arcing. Arcing damage in the form of small pits and so on may then occur on the bearing raceway.

As a result of such arcing, premature bearing failure may occur. For instance, bearing failure may result from accumulated arcing-caused pitting or other damage of the bearing raceway and/or from deteriorated bearing grease due to increased local temperatures on the raceway caused by arcing.

Several conventional mitigation approaches are known. Each suffers substantial limitations, selected ones of which are briefly described below.

In a first conventional approach, an alternative path is created for discharge of stored voltage. Such a path might be created through use of a grounding brush or grounding ring installed on an endshield of a given motor to provide a higher conductivity path to direct discharge flows away from the bearing.

However, this approach requires a physical grounding point or face to continuously touch the shaft with direct current flow. This physical contact point or face will be subject to various factors associated with the given field of use, including but not limited to humidity, temperature, and contamination, each of which may impact the continuity and effectiveness of the contact between the brush and shaft. This approach also requires consistent monitoring of the brush or ring (for instance, by a field service crew) to ensure the primary contact point is not worn off. Still further, professional installation of the grounding brush or ring is necessary to ensure proper mechanical dimensions relative to the shaft and endshield. For instance, tight tolerances in concentricity between the brush and the shaft must be achieved. Further still, the function of the grounding brush or ring strongly relies on the continuity of the path to ground. Contamination or disruption of the grounding path (for instance, via a rusted ground tap or broken ground ring) will result in failure of the attempted solution. Finally, it is noted that such devices are sparking devices.

In a second approach, an insulation layer is provided on one or more elements of the bearing as manufactured. For instance, a high dialectical strength ceramic coating material may be provided on the rolling elements of the bearing.

However, commercially available ceramic bearings have size limitations, with no solution available at present for industrial applications requiring, for instance, high horsepower ratings.

A third approach is an alternative insulation-based method in which insulative papers, tapes, and/or films are layered in one or more relevant locations to provide sufficient electrically insulative properties.

However, these prior attempts at addressing the problem present their own problems.

In a fourth approach, another insulation-based method, an electrically insulative engineering epoxy such as diglycidyl ether diethylenetriamine is applied in the form of a paste around the bearing journal area (that is, where the bearing mechanically mates with the shaft). The paste then cures and is machined as necessary to match the bearing inner diameter.

However, such cured epoxy pastes again fail to provide sufficient mechanical properties and may particularly be problematically brittle. Deterioration of the monomer chain as a result of exposure of the epoxy to field aging may occur, shortening the lifespan of the epoxy. Furthermore, if epoxy failure takes place, premature damage to other mechanical assemblies may occur, perhaps necessitating retrieval of the motor from the field and transport thereof to a service center.

In a fifth approach, an inductor or surge arrester is used to mitigate electrical discharge. For instance, a metal-oxide varistor (MOV) or a bidirectional transient voltage suppressor (TVS) diode might be used. The latter may be used as a voltage spike suppressor once a discharge is identified, filtering out the discharge and then preventing arcing from occurring on the bearing.

However, such mitigation approach requires modification of the electrical circuit on an existing product, resulting in lost operating time and in costs associated with engineering design. Once a failure has occurred, on-field retrofitting/repair is also not feasible.

### SUMMARY

According to one aspect of the present invention, an electromagnetic apparatus produces an asymmetrical magnetic field. The electromagnetic apparatus includes a stator and a rotor rotatable relative to the stator. The stator includes electrically conductive wiring subject to non-zero voltage input. The rotor includes an electrically conductive rotor shaft having a shaft voltage induced therein. The electromagnetic apparatus further includes a bearing rotatably supporting the rotor shaft and an electrically insulative arcing shield disposed in overlying engagement with the bearing. The arcing shield comprises a fibrous composite material. The fibrous composite material includes a plurality of fibers and a resin.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is front perspective view of a motor assembly in accordance with a first preferred embodiment of the present invention;

FIG. 2 is an alternative, partially sectioned perspective view of the motor assembly of FIG. 1, particularly illustrating the placement of the arcing shields radially between the rotor bearings and shaft thereof;

FIG. 3 is an exploded perspective view of the rotor shaft and arcing shields of FIG. 2;

FIG. 4 is a cross-sectional side view of the rotor shaft and arcing shields of FIG. 3;

FIG. 4a is a greatly enlarged cross-sectional side view of the portion 4a of FIG. 4, particularly illustrated the layered construction of the illustrated one of the arcing shields;

FIG. 5a is an exploded perspective view of a bearing and an arcing shield in accordance with a second preferred embodiment of the present invention, prior to installment of the arcing shield onto the bearing;

FIG. 5b is a perspective view of the assembled arcing shield and bearing of FIG. 5a;

FIG. 6a is an exploded perspective view of a bearing and an arcing shield in accordance with a third preferred embodiment of the present invention, prior to installment of the arcing shield onto the bearing;

FIG. 6b is a perspective view of the assembled arcing shield and bearing of FIG. 6a;

FIG. 7a is an exploded perspective view of an endshield and an arcing shield in accordance with a fourth preferred embodiment of the present invention, prior to installment of thearcing shield onto the endshield; and

FIG. 7b is a perspective view of the assembled arcing shield and endshield of FIG. 7a.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the embodiments.

Furthermore, unless specified or made clear, the directional references made herein with regard to the present invention and/or associated components (for instance, top, bottom, upper, lower, inner, outer, and so on) are used solely for the sake of convenience and should be understood only in relation to each other. For instance, a component might in practice be oriented such that faces referred to as “top” and “bottom” are sideways, angled, inverted, and so on relative to the chosen frame of reference.

### Overview

In a broad sense, the present invention pertains to the use of one or more fibrous composite arcing shields to prevent electrical arcing associated with one or more bearings of an electromagnetic apparatus. The electromagnetic apparatus may be an electric motor, a power generator, or another electrical device associated with generation of or use of a magnetic field.

As will be discussed in greater detail below, the fibrous composite material at least in part constitutes the arcing shield and comprises a plurality of fibers impregnated with a resin. Areas of the electromagnetic apparatus suitable for application of or positioning of the arcing shield include but are not necessarily limited to the bearing journal areas, the inner diameters of the bearings, the outer diameters of the bearings, and/or the inner diameters of the bearing seats (as defined by endshields or similar).

### First Embodiment: Wrap-Formed Arcing Shield Applied to Motor Shaft

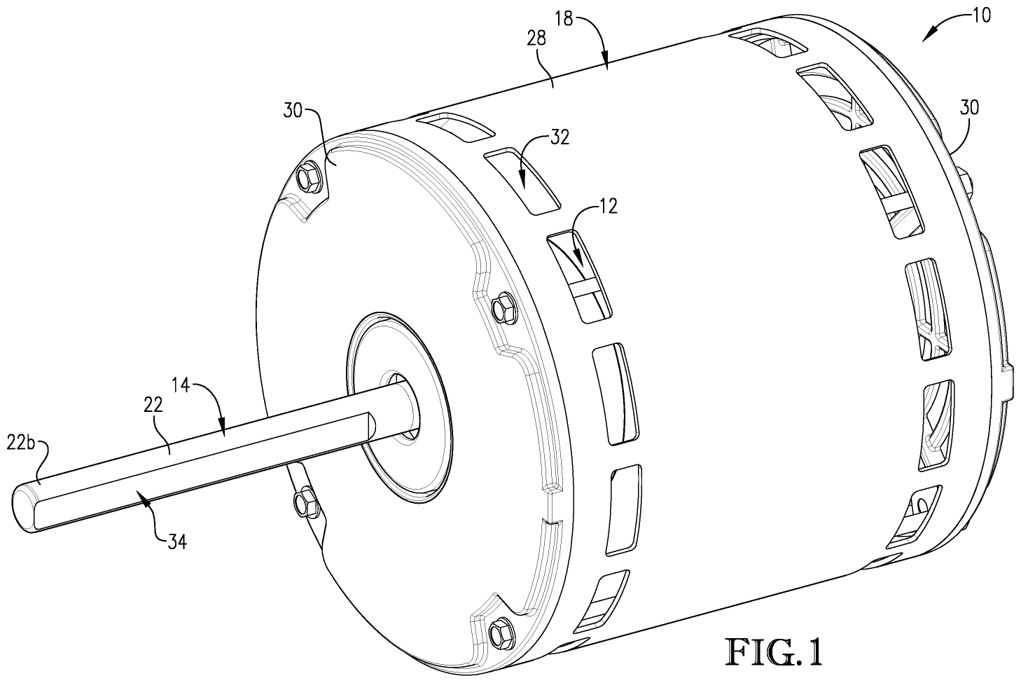

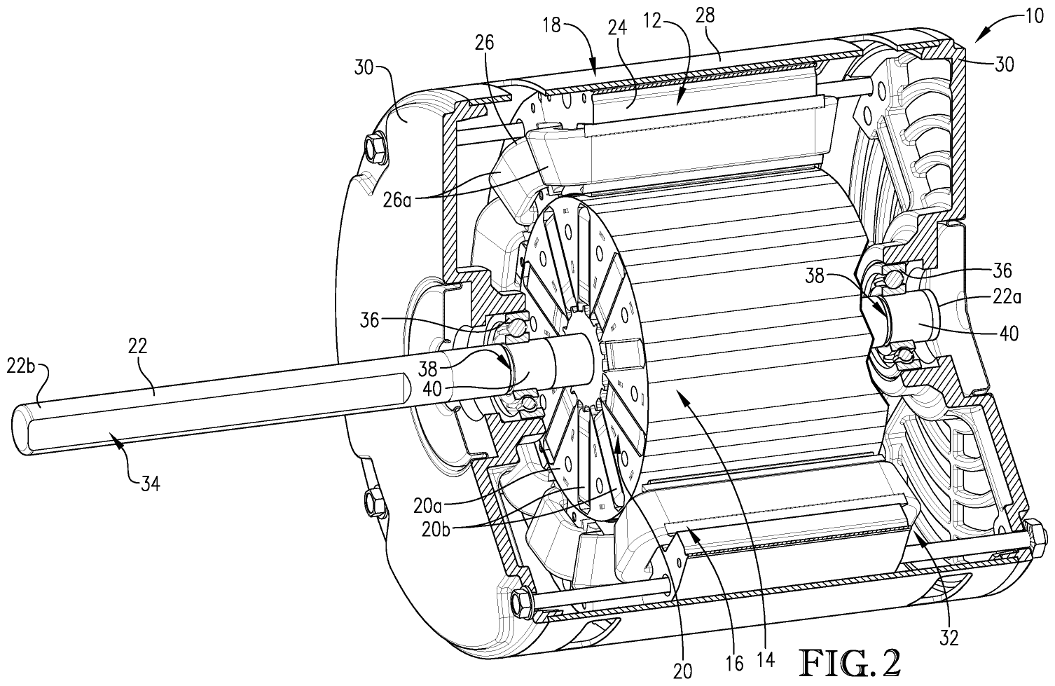

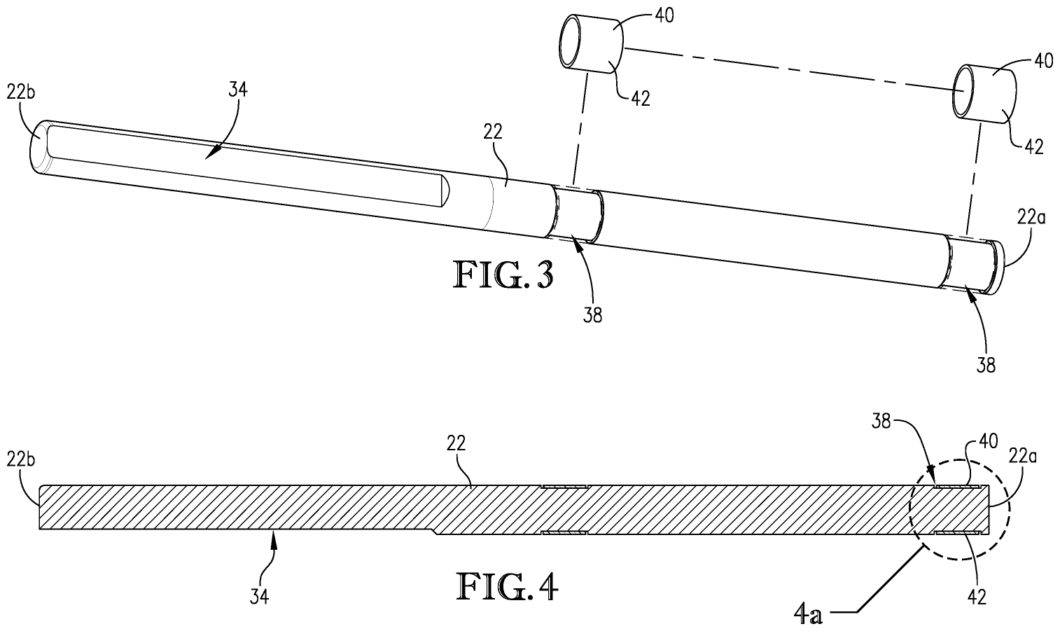

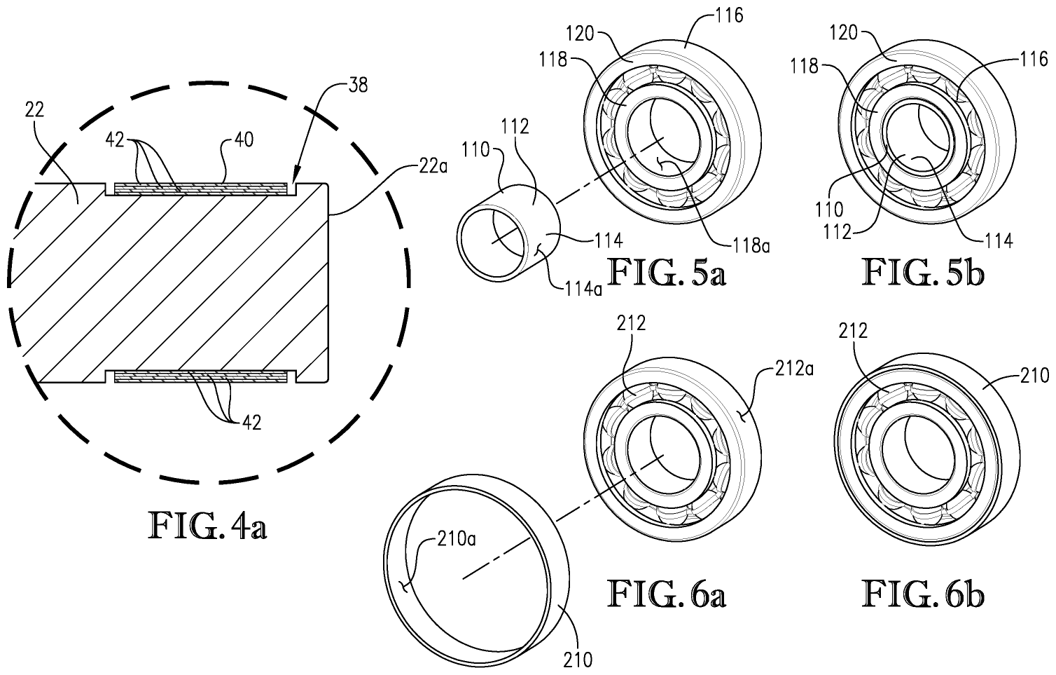

With initial reference to FIGS. 1 and 2, an electromagnetic assembly in the form of a motor assembly 10 includes a motor 12. The motor 12 includes a rotor 14 and a stator 16. The motor assembly 10 further includes a housing 18 at least substantially receiving the rotor 14 and the stator 16.

The rotor 14 includes a rotor core assembly 20 including a core 20a and a plurality of magnets 20b. The rotor 14 further includes a shaft 22 rotatable about an axis.

The stator 16 includes a stator core 24 and electrically conductive wiring 26 forming a plurality of coils 26a.

The stator 16 at least substantially circumscribes the rotor 14, with the motor 12 therefore being an inner rotor motor. Other motor configurations, including outer rotor motors and dual rotor motors, fall within the scope of some aspects of the present invention, however.

The housing 18 preferably includes a shell 28 and a pair of axially opposed endshields 30. The shell 28 extends between and interconnects the endshields 30, such that the shell 28 and the endshields 30 cooperatively define a motor chamber 32 that receives the stator 16 and the rotor core assembly 20 therein.

In a preferred embodiment, the shaft 22 includes a lead end 22a and an output or opposite lead end 22b. The output end 22b may include a notch 34 or other form of key to facilitate engagement with a driven device or mechanism (not shown).

The motor 12 is preferably a three-phase variable frequency or variable speed motor producing an asymmetrical magnetic field. The stator wiring 26 is preferably subject to non-zero voltage input, and the rotor shaft 22 preferably has a shaft voltage induced therein.

It is noted that the motor assembly 10 as broadly described above is in accordance with a preferred embodiment of the present invention. However, as will be apparent to those of ordinary skill in the art, numerous modifications to the motor assembly in general and/or to specific components thereof are permissible according to some aspects of the present invention. That is, the inventive features described in detail below may in some instances alternatively be applied to motor assemblies of other general types or to motor assemblies including components having features varying from those described above. For instance, split-phase capacitor run motors also produce an asymmetrical magnetic field and fall within the scope of some aspects of the present invention. Furthermore, aspects of the present invention are equally applicable to other non-motor electromagnetic apparatuses such as generators. In a general sense, however, the present invention may be broadly understood as most applicable to electromagnetic apparatuses producing an asymmetrical magnetic field.

The motor assembly 10 preferably includes a pair of bearings 36 seated in corresponding ones of the endshields 30 and each encircling the shaft 22. The bearings 36 cooperatively rotatably support the shaft 22 and, more broadly, the rotor 14, on the endshields 30.

In greater detail, a pair of axially spaced apart, circumferentially extended bearing journals 38 are defined in the shaft 22 (for instance, in the form of circumferential recesses). Arcing shields 40 are disposed in corresponding ones of the journals 38, and the corresponding bearings 36 are installed thereover. The arcing shields 40 are thus disposed in contact with and in overlying engagement with corresponding ones of the bearings 36. “Overlying engagement” will be defined in detail below.

Alternatively stated, the arcing shields 40 are disposed radially between the shaft 22 and the corresponding ones of the bearings 36 such that the bearings 36 are spaced radially from the shaft 22.

Stated in yet another way, each bearing 36 encircles or extends around a corresponding one of the arcing shields 40.

In the illustrated embodiment, each arcing shield 40 extends axially past at least one axial margin of the corresponding bearing 36 (see FIG. 2). Such extension provides a margin for error in relative positioning of corresponding ones of the shields 40 and bearings 36 relative to each other, ensuring that the shields 40 are still disposed radially between the shaft 22 and the corresponding bearings 36 if slight axial shaft or bearing mispositioning occurs. Even if positioning is accurate, however, the portion of each arcing shield that extends past the axial bearing margins may nevertheless aid in improved arcing resistance or prevention, as discussed below. It is permissible and even preferable according to some aspects of the present invention, however, for the arcing shields and bearings to share equal axial dimensions.

Each arcing shield 40 comprises an electrically insulative and mechanically robust fibrous composite material. The fibrous composite material includes a plurality of fibers in a matrix comprising a resin.

The fibers preferably include glass fibers, oxidized polyacrylonitrile fibers, carbon fibers, and/or aromatic polyamide (aramid) fibers such as Kevlar® fibers. The fibers may be continuous, chopped, or a combination thereof.

The glass fibers may be E-glass fibers, S-glass fibers, and/or C-glass fibers. For instance, in a preferred embodiment of the present invention, the fibrous composite material is a fiberglass composite including continuous E glass (SiO₂+CaO+Al₂O₃ and Fe₂O₃) fibers.

The resin may be an epoxy resin, a vinyl ester resin, a polyester resin, or a combination thereof.

The resin preferably comprises between about twenty (20) percent and about fifty-five (55) percent of a total weight of the fibrous composite material and significantly enhances the mechanical properties thereof, as discussed herein.

More particularly, in a broad sense, the fibrous composite material features a low density, an excellent tensile strength, superb elongation, and a very high glass transition temperature.

For instance, the material density is preferably less than three (3) g/cm³, more preferably less than two (2) g/cm³, and most preferably less than about one and five tenths (1.5) g/cm³. In some embodiments (for instance, when utilizing a unidirectional carbon fiber imbedded in a polymer matrix), densities of less than nine ten-thousandths (0.0009) g/cm³ may be achieved.

The tensile strength of the fibrous composite material, which significantly exceeds tensile strengths associated with typical insulation solutions, is preferably greater than about nine (9) ksi and, in some instances (for instance, when the fibers are carbon fibers) may exceed about two hundred (200) ksi.

The elongation at failure of the fibrous composite material is preferably greater than three (3) percent and more preferably greater than four (4) percent in some embodiments due to the continuous fibers thereof. Again, such mechanical property significantly exceeds that of typical insulation solutions.

The thermal stability profile of the arcing shields 40 is also significant. More particularly, it is essential that the fibrous composite material remain stable even at high operating temperatures. For instance, a preferred fibrous composite material has a glass transition temperature greater than about eighty (80)° C., more preferably greater than about one hundred (100)° C., and most preferably greater than about one hundred and twenty (120)° C., substantially higher than that of a typical insulation solution. This suggests the arcing shields 40 of the present invention are less prone to thermal aging.

It is also noted that the resin forming the matrix of the fibrous composite material is preferably a thermosetting polymer (that is, a thermoset).

Curing is most preferably via an endothermic reaction, with a cure time most preferably being less than about three (3) hours.

The fibrous composite material may additionally be subjected to a post-cure process. Such process might include, for instance, heat treatment or oven cure at between about one hundred forty (140)° C. and about two hundred (200)° C. for about forty (40) minutes.

In the illustrated embodiment, each arcing shield 40 in its final state is in the form of a layered fibrous composite cylindrical sheet material 42. The cylindrical sheet material 42 is preferably formed from a continuous elongated tape 42 (alternatively stated, a continuous elongated sheet or strip) repeatedly wrapped around the shaft 22 to form one or more overlying tape or sheet layers 42a. That is, the tape 42 is wrapped arcuately around or about, encircles, or forms one or more loops around or about the shaft 22.

The tape 42 is preferably applied around respective ones of the bearing journals 38, such that the arcing shields 40 are at least in part disposed therein.

The thickness of the fibrous composite cylindrical sheet material 42 around the applicable areas (in the present embodiment, such areas being the bearing journals 38) can be readily controlled through how many rounds or layers of tape 42 are applied to or around the applicable work area. In a preferred method, the tape 42 is wrapped about the shaft 22 until an outer diameter of the cylindrical sheet material 42 is equal to or greater than a desired bearing inner diameter.

After curing of the wrapped material 42, a post-cure process may take place as noted above.

When curing and post-curing (if applicable) are complete, the material 42 may be post-machined (for instance, turned, milled, ground, and/or polished) to achieve any specified dimensions associated with the outer diameter, surface roughness, tolerance, and so on. For instance, rough or “sloppy” edges of the material 42 are preferably removed, and modification of the outer surface of the material 42 preferably takes place to produce a smooth, dimensionally appropriate radially outer arcing shield mating surface 40a suitable for secure and consistent engagement with a radially inner bearing mating surface 36a defined by the corresponding one of the bearings 36.

The bearings 36 are thereafter installed over the arcing shields 40 such that the bearing mating surface 36a overlies (alternatively, contacts, engages, and/or mates with) the arcing shield mating surface 40a. The arcing shields 40 thus form an insulation layer to electrically isolate the rotor shaft 22 (and, more broadly, the rotor 14) from the bearings 36.

Alternatively stated, as noted above, each arcing shield 40 is disposed in overlying engagement with a corresponding one of the bearings 36. It is noted that “overlying engagement” as used herein includes configurations in which direct contact occurs between the arcing shield 40 and the bearing 36, as illustrated, and configurations in which an engineering adhesive or other securement aid is provided between the arcing shield and the bearing to aid in fixing the arcing shield and the bearing relative to one another. As will be readily understood by those of ordinary skill in the art, any such adhesive or other aid should be chosen so as to not destroy the electrically insulative functionality of the arcing shields. Furthermore, the axial locations of the arcing shields 40 relative to corresponding ones of the bearings 36 should be such that there is no open radial gap or free area between each bearing 36 and the shaft 22. That is, any such radial space between a given one of the bearings 36 and the shaft 22 is either occupied by the corresponding arcing shield 40 itself or filled by the associated adhesive or other securement aid.

The motor assembly 10 is then ready for field service, with bearing arcing prevented or at least substantially prevented.

It is particularly noted that the above-described embodiment is advantageous in a variety of circumstances, including a new build of the motor assembly 10.

It is also noted that, although wrapping of the tape 42 around the shaft 22 is most preferred, the tape might alternatively or additionally be applied to other relevant areas associated with potential unwanted electrical activity, such as the inner and/or outer diameters of the bearings themselves or the bearing seats defined by the motor endshields.

### Second Embodiment: Pre-Formed Tubular Arcing Shield Fit to Bearing Inner Diameter

A second preferred embodiment of an arcing shield is illustrated in FIGS. 5a and 5b. It is initially noted that, with certain exceptions to be discussed in detail below, many aspects of the arcing shield 110 of the second embodiment are the same as or very similar to those described in detail above in relation to the arcing shield 40 of the first embodiment. Therefore, for the sake of brevity and clarity, redundant descriptions and numbering will be generally avoided here. Unless otherwise specified, the detailed descriptions presented above with respect to the first embodiment should therefore be understood to apply at least generally to the second embodiment, as well.

Turning now to FIGS. 5a and 5b, an arcing shield 110 similar in size, shape, and general positioning to the arcing shields 40 of the first preferred embodiment is instead pre-formed into a tubular shape. That is, whereas the arcing shields 40 of the first preferred embodiment are formed directly on the shaft 22 via wrapping of the elongated tape 42, each arcing shield 110 of the second preferred embodiment is pre-formed into a tubular shape and thereafter placed on an appropriate portion of the motor assembly.

More particularly, in a preferred approach, an electrically insulative and mechanically robust fibrous composite material 112 (including a plurality of fibers in a matrix comprising a resin, as discussed above) is initially provided in a sheet form. The sheet is then pre-molded into an elongated tube shape or hollow rod per dimensional requirements. Such requirements might be in accordance with standards provided by NEA, IEC, and/or ANSI, or as otherwise specified for the desired motor assembly. The formed elongated tube is then cut to a desired axial length (if necessary) to form a ring or tube 114 corresponding in axial length to the associated bearing journal and/or bearing inner surface.

Alternatively, the tube 114 might be pre-manufactured via thermal extrusion using chopped fibers blended with thermosetting material in powder form, followed by cutting to the desired length.

As shown in FIG. 5b, the ring or tube 114 is preferably inserted into and fixed to a bearing 116. More particularly, the bearing 116 includes an inner race 118 and an outer race 120. The inner race 118 defines an inner bearing surface 118a. The tube 114 defines an outer tube surface 114a. The outer tube surface 114a and the inner bearing surface 118a preferably contact each other in overlying engagement or are separated only by engineering adhesive and/or other aids provided for improved securement, as discussed in greater detail above.

Alternatively described, the bearing 116 encircles the tube 114 or, more broadly described, the arcing shield 110.

Upon repetition of this insertion process on the other of the bearings (not shown), the rotor (not shown) is isolated from ground to prevent arcing discharge.

It is particularly noted that such an embodiment is suitable both for new builds and for on-field retrofit. Furthermore, the arcing shield 110 may be used with any of a variety of bearing types.

Although insertion of a pre-formed tube 114 into the bearing 116 is preferred, an alternative tape-based formation approach similar to that of the arcing shield 40 of the first preferred embodiment is permissible according to some aspects of the present invention. For instance, the material might initially be provided in the form of a flat sheet, then curved either pre-emptively or on-site to facilitate application directly to the inner bearing surface of the bearing. One or more layers could be provided to achieve the desired thickness, and the resulting arcing shield could be machined down to the appropriate shaft outer dimensions, axial length, and so on as needed.

### Third Embodiment: Pre-Formed Tubular Arcing Shield Fit to Bearing Outer Diameter

A third preferred embodiment of an arcing shield is illustrated in FIGS. 6a and 6b. It is initially noted that, with certain exceptions to be discussed in detail below, many aspects of the arcing shield 210 of the third embodiment are the same as or very similar to those described in detail above in relation to the arcing shield 40 of the first embodiment and the arcing shield 110 of the second embodiment. Therefore, for the sake of brevity and clarity, redundant descriptions and numbering will be generally avoided here. Unless otherwise specified, the detailed descriptions presented above with respect to the first and second embodiments should therefore be understood to apply at least generally to the third embodiment, as well.

Turning now to FIGS. 6a and 6b, a bearing 212 is retrofitted with the arcing shield 210 at an outer diameter thereof. Formation of the arcing shield 210 is preferably similar to that described above with regard to the pre-formed molded or extruded arcing shield 110 of the second preferred embodiment, although a tape- or sheet-based formation approach similar to that of the arcing shield 40 of the first preferred embodiment is permissible according to some aspects of the present invention.

The arcing shield 210 of the third preferred embodiment is fitted onto an outer race 214 of the bearing 212. More particularly, the arcing shield 210 includes an inner shield or tube surface 210a disposed in overlying engagement with an outer bearing surface 212a. The arcing shield 210 thus encircles the bearing 212.

Upon repetition of this process on the other of the bearings (not shown), the rotor (not shown) is isolated from ground to prevent arcing discharge.

Similar to the arcing shield 110 of the second preferred embodiment, the arcing shield 210 is well suited both for implementation on new builds and for on-field retrofit. Furthermore, the arcing shield 210 may be used with any of a variety of bearing types.

### Fourth Embodiment: Endshield Retrofit

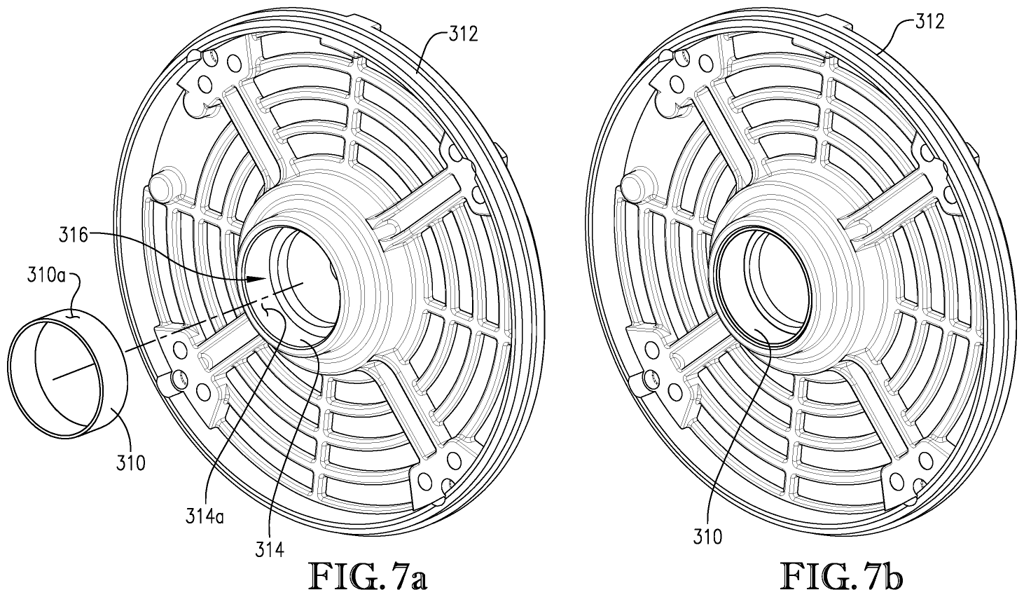

A fourth preferred embodiment of an arcing shield is illustrated in FIGS. 7a and 7b. It is initially noted that, with certain exceptions to be discussed in detail below, many aspects of the arcing shield 310 of the fourth embodiment are the same as or very similar to those described in detail above in relation to the arcing shield 40 of the first embodiment, the arcing shield 110 of the second embodiment, and the arcing shield 210 of the third embodiment. Therefore, for the sake of brevity and clarity, redundant descriptions and numbering will be generally avoided here. Unless otherwise specified, the detailed descriptions presented above with respect to the first, second, and third embodiments should therefore be understood to apply at least generally to the fourth embodiment, as well.

Turning now to FIGS. 7a and 7b, a motor endshield 312 is fitted with the arcing shield 310. Formation of the arcing shield 310 is preferably similar to that described above with regard to the pre-formed molded or extruded arcing shields 110 and 210 of the second and third preferred embodiments, respectively, although a tape- or sheet-based formation approach similar to that of the arcing shield 40 of the first preferred embodiment is permissible according to some aspects of the present invention.

In a preferred embodiment, the endshield 312 includes a bearing seat 314 defining a bearing bore 316 and presenting an inner bearing seat surface 314a. The arcing shield 310 presents an outer tube surface 310a and is fitted into the inner diameter of the bearing seat 314 to overlie the inner bearing seat surface 314a thereof. That is, the bearing seat 314 is configured to support a bearing (not shown in FIGS. 7a and 7b) in a manner similar to that illustrated in FIGS. 1 and 2, with the arcing shield 310 being disposed radially between the bearing seat 314 and the bearing.

Upon repetition of this process on the other of the endshields (not shown), the rotor (not shown) is isolated from ground to prevent arcing discharge.

### Advantages

As will be readily apparent to those of ordinary skill in the art, the present invention is highly advantageous. Several advantages pertaining to the material characteristics of the preferred fibrous composite with resin impingement have been elucidated above, including both the electrically insulative and mechanically robust properties thereof.

It is additionally noted that, in an elongated tape or flexible sheet approach, the preferred fibrous composite material is flexible and easy to apply around the work area. The depth or thickness of the material can be easily controlled through the number of encirclements (alternatively, loops or layers) of the tape or sheet on or around the work area.

In the alternative pre-formed tube-type approach, the materials may be conveniently processed through thermal extrusion or pre-molded into a standard shape, then cut into length as needed for an after-market solution. A pre-formed tube can also be easily sized and cut for in-the-field retrofitting.

Still further, the present inventive approach is less prone to environmental contamination in comparison to a grounding brush or similar solutions that are typically installed outside a motor and thus are very sensitive to environmental dust, debris, and/or other contaminants. The current invention is disposed inside the motor housing and thus in a contained, less environmentally prone area.

It is also not necessary when using the present inventive approach to maintain a continuous ground path. Rather, the current invention isolates arcing discharge regardless of whether or not the associated electromagnetic apparatus is properly grounded. The effectiveness of the invention will therefore generally not be impacted by installation location.

Standard bearings may also be utilized, with the rolling elements (for instance, balls, cylinders, or needles), the inner race, and the outer race thereof all permissibly consisting of electrically conductive material. For instance, it is not necessary to provide the rolling elements with an electrically insulative coating such as ceramic, or to otherwise deviate from standard bearing configurations.

The present invention also utilized a spark-free approach to bearing insulation, in contrast with many conventional solutions.

Further still, it is noted that the present approach additionally restricts or prevents chemical corrosion and mechanical fretting between the mating surfaces.

Finally, the present invention is well suited for a broad variety of applications, including both new build and retrofit applications for motors, power generators, and other electrical devices. Suitable devices are not limited by power source (for instance, alternating current versus direct current) or frame size, with relevant fields including but not limited to appliances; heating, ventilation, and air conditioning; refrigeration; power generation; and so on.

### Conclusion

Features of one or more embodiments described above may be used in various combinations with each other and/or may be used independently of one another. For instance, although a single disclosed embodiment may include a preferred combination of features, it is within the scope of certain aspects of the present invention for the embodiment to include only one (1) or less than all of the disclosed features, unless the specification expressly states otherwise or as might be understood by one of ordinary skill in the art. Therefore, embodiments of the present invention are not necessarily limited to the combination(s) of features described above.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. An electromagnetic apparatus producing an asymmetrical magnetic field, said electromagnetic apparatus comprising:
a stator including electrically conductive wiring subject to non-zero voltage input;
a rotor rotatable relative to the stator,
said rotor including an electrically conductive rotor shaft having a shaft voltage induced therein;
a bearing rotatably supporting the rotor shaft; and
an electrically insulative arcing shield disposed in overlying engagement with the bearing,
said arcing shield comprising a fibrous composite material,
said fibrous composite material including a plurality of fibers and a resin.

2. The electromagnetic apparatus of claim 1,
said fibers including glass fibers.

3. The electromagnetic apparatus of claim 2,
said glass fibers being selected from the group consisting of E-glass fibers, S-glass fibers, and C-glass fibers.

4. The electromagnetic apparatus of claim 1,
said fibers including oxidized polyacrylonitrile fibers.

5. The electromagnetic apparatus of claim 1,
said fibers including carbon fibers.

6. The electromagnetic apparatus of claim 1,
said fibers including aromatic polyamide fibers.

7. The electromagnetic apparatus of claim 1,
said resin being selected from the group consisting of epoxy resin, vinyl ester resin, polyester resin, and combinations thereof.

8. The electromagnetic apparatus of claim 1,
said resin comprising between about 20% and about 55% of a total fibrous composite material weight.

9. The electromagnetic apparatus of claim 1,
said fibrous composite material having a tensile strength greater than about 9 ksi.

10. The electromagnetic apparatus of claim 9,
said fibrous composite material having a tensile strength greater than about 200 ksi.

11. The electromagnetic apparatus of claim 1,
said fibrous composite material having an elongation percentage greater than about 3%.

12. The electromagnetic apparatus of claim 1,
said fibrous composite material having a glass transition temperature greater than about 80° C.

13. The electromagnetic apparatus of claim 1,
said resin comprising a thermosetting polymer.

14. The electromagnetic apparatus of claim 1,
said fibrous composite material having a cure time of less than about 3 hours.

15. The electromagnetic apparatus of claim 1,
said arcing shield comprising an elongated tape encircling the rotor shaft,
said arcing shield being disposed radially between the bearing and the shaft such that the bearing is spaced from the shaft.

16. The electromagnetic apparatus of claim 1,
said arcing shield comprising a pre-formed tube.

17. The electromagnetic apparatus of claim 16,
said tube being positioned such that one of said bearing and said tube encircles the other of said bearing and said tube.

18. The electromagnetic apparatus of claim 17, further comprising:
an endshield,
said endshield defining a bearing seat supporting the bearing,
said tube overlying said bearing seat so as to be disposed radially between the bearing seat and the bearing.

19. The electromagnetic apparatus of claim 1,
said arcing shield comprising an extruded tube.
